(19) United States
(12) Patent Application Publication
(10) Pub. No.: US 2015/0175118 A1
(43) Pub. Date: Jun. 25, 2015

(54) Motor Vehicle with an Airbag Module

(71) Applicant: Bayerische Motoren Werke Aktiengesellschaft, Muenchen (DE)

(72) Inventors: Michael HATTENSPERGER, Inning am Holz (DE); Christian MAURER, Karlsdorf/Forstern (DE); Reinhold SCHREFF, Postau (DE); Andreas GELTINGER, Marklkofen (DE)

(21) Appl. No.: 14/639,225

(22) Filed: Mar. 5, 2015

Related U.S. Application Data
(63) Continuation of application No. PCT/EP2013/067432, filed on Aug. 22, 2013.

(30) Foreign Application Priority Data
Sep. 6, 2012 (DE) 10 2012 215 840.5

(51) Int. Cl. B60R 21/205

(52) U.S. Cl. CPC B60R 21/205; B60R 2021/0004

(57) ABSTRACT

An airbag module for a motor vehicle has at least one airbag and at least one gas generator which are housed in an airbag housing. The airbag housing can be detachably fixed to at least one abutting wall area by at least one fixing device, wherein the fixing device is formed as a push-in and slide connection. The airbag housing is placed on the wall section for mounting and is longitudinally displaced into a holding position in which the airbag housing is held in a form-locking manner by the fixing frame. When the airbag module is longitudinally displaced into the holding position, the airbag housing engages with the fixing frame, and therefore the airbag housing is prevented from being longitudinally displaced out of the holding position.

### CROSS REFERENCE TO RELATED APPLICATIONS

This application is a continuation of PCT International Application No. PCT/EP2013/067432, filed Aug. 22, 2013, which claims priority under 35 U.S.C. §119 from German Patent Application No. 10 2012 215 840.5, filed Sep. 6, 2012, the entire disclosures of which are herein expressly incorporated by reference.

This application contains subject matter related to U.S. application Ser. No. ______, entitled “Motor Vehicle with an Airbag Module” filed on even date herewith.

### BACKGROUND AND SUMMARY OF THE INVENTION

The invention relates to a motor vehicle with an airbag module which has at least one airbag and at least one gas generator, which are accommodated in an airbag housing, the airbag module being fixable with the airbag housing on a fixing frame, which is connected with a wall section of a dashboard.

From German Patent document DE 103 46 012 A1, a motor vehicle having an airbag module is known, which has at least one airbag and at least one gas generator, which are accommodated in an airbag housing. The airbag housing can be detachably fixed to at least one adjoining wall area by way of at least one fixing device, the fixing device being constructed as a push-in and slide connection based on the keyhole principle.

It is an object of the invention to provide a motor vehicle having an airbag module which can be fixed in a simple manner to an adjoining wall area.

This and other objects are achieved by a motor vehicle having an airbag module according to the invention, having at least one airbag and at least one gas generator, which are accommodated in an airbag housing. This airbag module can be fixed with the airbag housing on a fixing frame, which is connected with a wall section of a dashboard of the motor vehicle. For the assembly, the airbag housing is placed on the wall section and is longitudinally displaced into a holding position, in which the airbag housing is form-lockingly held by the fixing frame. When the airbag module is longitudinally displaced, the airbag housing locks into the holding position at the fixing frame, so that the airbag housing is secured against a longitudinal displacement out of the holding position. This is a particularly simple method of holding the airbag module securely in its holding position. The assembly takes place in an extremely process-reliable and rapid manner. No additional aids are required. The fixing of the airbag module by way of a form-locking, into which the module is pushed, and the subsequent securing of the holding position, for example, by way of a clamp, therefore represents an extremely cost-effective and fast type of fixing.

Viewed in the longitudinal displacement direction, the airbag housing has at least one clamp for engaging on a forward edge area and/or on a rearward edge area. The clamp may advantageously be further developed as a classic snap-in tongue having a detent which, during the sliding of the airbag housing, is first elastically deformed until the detent engages in a recess or indentation.

Ideally, the at least one clamp is constructed in one piece with the airbag housing. This is a particularly simple and therefore cost-effective manner of mounting the at least one clamp at the airbag housing. For this purpose, the airbag housing may, for example, consist of glass-fiber or glass-bead reinforced plastic. By means of a corresponding design of the die, the at least one clamp can, in particular, be easily molded directly onto such an airbag housing.

For the form-locking between the airbag housing and the fixing frame, the airbag housing advantageously has several laterally outward-projecting tongues on at least two opposite sides. In this case, the tongues arranged side-by-side on one side are each spaced from one another by at least one tongue width. The fixing frame has corresponding holding elements for the tongues of the airbag housing, so that the fixed airbag module is form-lockingly held by way of the tongues by the holding elements. For the fixing on the fixing frame, the airbag housing can be slid in the longitudinal direction of the two mutually opposite sides by way of the tongues into the holding elements.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of an airbag module of a vehicle, which is placed on a fixing frame; and

FIG. 2 is a schematic view of the airbag module illustrated in FIG. 1, after its placing on the fixing frame, including a detailed view of the airbag module in its holding position.

### DETAILED DESCRIPTION OF THE DRAWINGS

In the two figures, an airbag module 1 is illustrated which consists of an airbag housing 2, in which at least one airbag and at least one gas generator are accommodated. The airbag is used as a front passenger airbag, which is accommodated in a dashboard on the front passenger side. In the event of an accident, the airbag can pass through a wall section 3 of the dashboard facing the front passenger and deploy in front of the front passenger. The airbag module 1 is mounted by way of the airbag housing 2 in the dashboard on the wall section 3 facing the front passenger. The forces acting when the airbag is triggered are fairly high. Correspondingly, the stress acting upon the connection between the airbag housing 2 and the wall section 3 of the dashboard is also high.

The airbag housing 2 is a plastic injection-molded part consisting of a plastic material reinforced by glass fiber and/or by glass beads. It has an oblong shape with two mutually parallel longitudinal sides 4. A plurality of tongues 5 each project laterally toward the outside from these mutually opposite longitudinal sides 4. Along its longitudinal dimension, each longitudinal side 4 has a plurality of, in each case, equally wide tongues 5 arranged at uniform distances from one another. In this case, the distance d between two tongues 5 is greater than the width b of the tongues 5. All tongues 5 of the airbag housing 2 are situated in a plane. The tongues 5 are constructed in one piece with the actual airbag housing 2. They are reinforced by way of additional ribbing. In addition, on the two narrow sides 10 of the airbag housing 2, two clamps, respectively, in the form of snap-in tongues 11 are arranged, which snap-in tongues 11 project to the outside in the plane of the tongues 5 and each have a detent. The snap-in tongues 11 with the detents are injection-molded in one piece with the airbag housing 2.

A fixing frame 6 is injection-molded on the interior side of the wall section 3 for accommodating the airbag housing 2. From the vehicle interior, the passengers always see only the exterior side of the wall section 3. The fixing frame 6 also extends in a plane. It is used for fixing the airbag housing 2 as well as for increasing the stiffness of the wall section 3 of the dashboard in the area of the front passenger airbag.

The fixing frame 6 consists of two mutually opposite side edges 7, which project in the manner of a web and whose ends are each mutually connected by way of a transverse section 8. Regularly spaced holding webs 9, as holding elements, in turn, project from these projecting side edges 7, which holding elements extend in the plane of the fixing frame and project toward the opposite side edge 7. The distance between the wall section 3 and the holding webs 9 corresponds to the thickness of the tongues 5. The distance between the mutually adjoining holding webs 9 on the side edges 7 is greater than the width b of the tongues 5. The side edges 7, as well as the at least one transverse section 8, and the holding webs 9, are each reinforced with additional ribbings injection-molded on in one piece. The two transverse sections 8 of the fixing frame 6 each have two recesses 13.

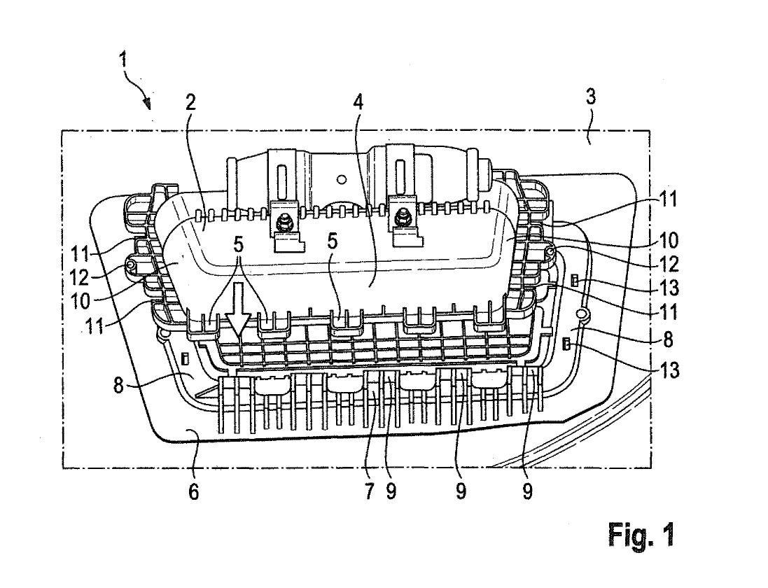

The fixing frame 6 is precisely coordinated with the airbag housing 2. For the mounting—as illustrated in FIG. 1—the airbag housing 2 can be placed on the wall section 3 of the dashboard in such a manner that the tongues 5 of the longitudinal edges 4 of the airbag housing 2 each come to be situated precisely between the holding webs 9 of the side edges 7 of the fixing frame 6 on the wall section 3 of the dashboard. The distance between the inwardly projecting holding webs 9 is too short for the airbag housing 2; the airbag housing 2 could not be placed on the wall section 3 here.

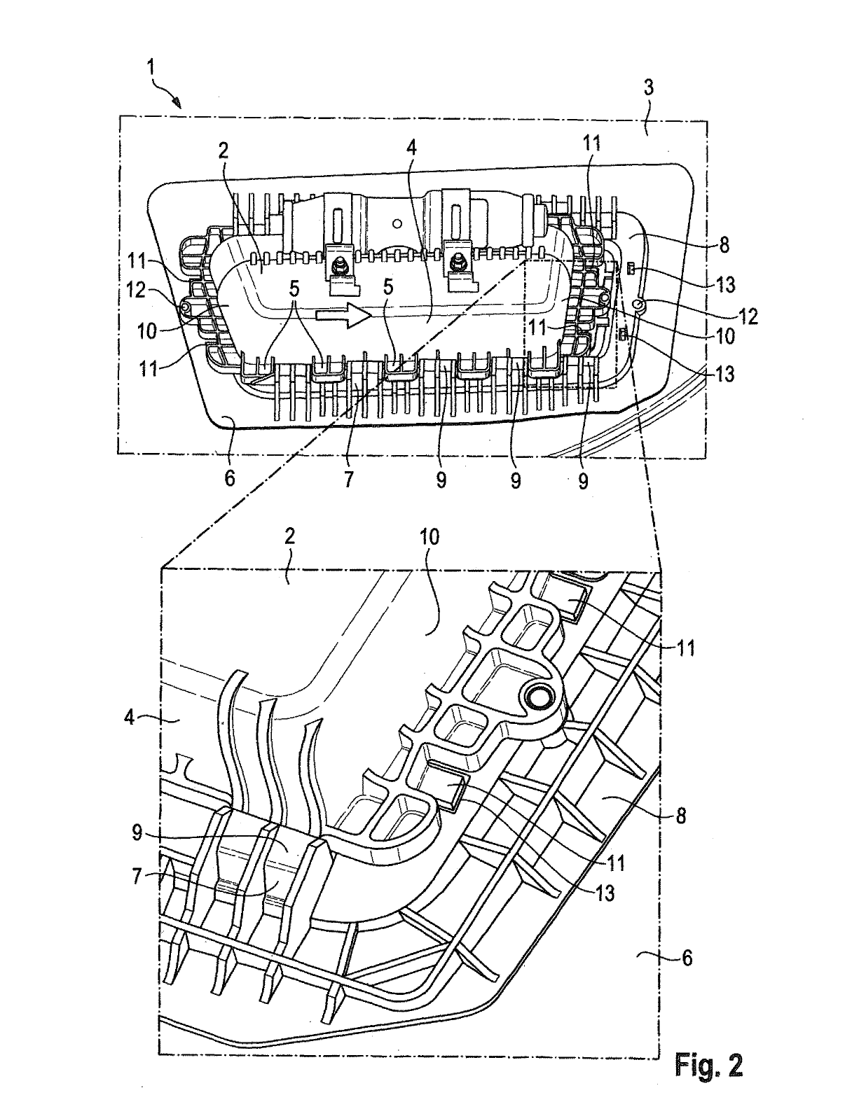

For the secure fixing of the airbag housing 2, the latter is now displaced, from the position on the wall section 3 and illustrated in FIG. 1, in the longitudinal direction of the airbag housing 2 by approximately the width b of one tongue 5. In this case, the tongues 5 push themselves in under the holding webs 9 of the side edges 7, as illustrated in the enlarged detailed view of FIG. 2. In this holding position, the airbag housing 2 is form-lockingly held by way of the tongues 5 between the holding webs 9 and the wall section 3 of the dashboard. During the displacing of the airbag housing 2, the snap-in tongues 11 with the detents are elastically pressed away from the wall section 3 by the fixing frame 6. When the holding position is reached, the detents are automatically pressed into the recesses 13 in the fixing frame 6 by the elastically pretensioned snap-in tongues 11, and lock there. The airbag housing 2 is thereby securely held in the holding position. During driving of the motor vehicle, the airbag housing can no longer undesirably shift relative to the fixing frame 6 as a result of shaking. In addition, after being pushed into the holding position, the airbag housing 2 can also be screwed on both sides to the fixing frame 6 by at least one screw, respectively. For this purpose, the airbag housing 2 and the fixing frame 6 have respective corresponding screw bosses 12.

This represents a very simple and robust method of fixing an airbag module 1 to a wall section 3.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A motor vehicle having an airbag module with at least one airbag and at least one gas generator, comprising:
an airbag housing that accommodates the at least one airbag and the at least one gas generator;
a fixing frame connectable with a wall section of a dashboard of the motor vehicle, the airbag housing being mounted on the fixing frame, wherein
for the mounting, the airbag housing is placed on the wall section and is longitudinally displaceable into a holding position in which the airbag housing is form-lockingly held by the fixing frame,
the airbag housing and/or the fixing frame is configured such that, during the longitudinal displacement into the holding position, the airbag housing locks at the fixing frame so as to be secured against longitudinal displacement out of the holding position.

2. The motor vehicle according to claim 1, further comprising:
at least one clamp configured to lock the airbag housing at the fixing frame, the clamp being mounted, viewed in a longitudinal displacement direction, at a forward edge area and/or a rearward edge area of the airbag housing.

3. The motor vehicle according to claim 2, wherein the clamp is formed in one-piece with the airbag housing.

4. The motor vehicle according to claim 1, further comprising:
several laterally outward-projecting tongues arranged on at least two opposite sides of the airbag housing, said tongues being arranged side-by-side on one side being spaced apart from one another by at least one tongue width; and
several corresponding holding elements arranged on the fixing frame, the corresponding holding elements being configured to form-lockingly hold the several laterally outward-projecting tongues of the airbag housing in order to fix the airbag module.

5. The motor vehicle according to claim 3, further comprising:
several laterally outward-projecting tongues arranged on at least two opposite sides of the airbag housing, said tongues being arranged side-by-side on one side being spaced apart from one another by at least one tongue width; and
several corresponding holding elements arranged on the fixing frame, the corresponding holding elements being configured to form-lockingly hold the several laterally outward-projecting tongues of the airbag housing in order to fix the airbag module.

6. The motor vehicle according to claim 4, wherein the airbag housing is pushable in the longitudinal displacement direction of the two sides such that the tongues move into the holding elements in order to fix the airbag housing on the fixing frame.

7. The motor vehicle according to claim 5, wherein the airbag housing is pushable in the longitudinal displacement direction of the two sides such that the tongues move into the holding elements in order to fix the airbag housing on the fixing frame.

8. The motor vehicle according to claim 6, wherein the fixing frame comprises at least two mutually opposite side edges projecting in a web manner from the wall section of the dashboard perpendicularly with respect to a plane of the fixing frame.

9. The motor vehicle according to claim 8, wherein radially spaced holding webs project from each perpendicularly projecting side edge toward the opposite side edge, said holding webs extending in the plane of the fixing frame to form the holding elements for the tongues.

10. The motor vehicle according to claim 9, wherein a distance between the wall section and the holding webs corresponds to a thickness of the tongues.

11. The motor vehicle according to claim 10, wherein a distance between mutually adjoining holding webs at a respective side edge is greater than the width of the tongues.

12. The motor vehicle according to claim 9, wherein a distance between mutually adjoining holding webs at a respective side edge is greater than the width of the tongues.

13. The motor vehicle according to claim 1, further comprising at least one screw configured to secure the airbag housing form-lockingly fixed to the fixing frame.
